(19) United States
(12) Patent Application Publication
(10) Pub. No.: US 2024/0094524 A1
(43) Pub. Date: Mar. 21, 2024

(54) LIGHT DEFLECTOR

(71) Applicant: Panasonic Intellectual Property Management Co., Ltd., Osaka (JP)

(72) Inventor: Takami ISHIDA, Osaka (JP)

(21) Appl. No.: 18/521,984

(22) Filed: Nov. 28, 2023

Related U.S. Application Data
(63) Continuation of application No. PCT/JP2022/018605, filed on Apr. 22, 2022.

(30) Foreign Application Priority Data
May 28, 2021 (JP) 2021-090474

(51) Int. Cl. G02B 26/08; G02B 26/10

(52) U.S. Cl. CPC G02B 26/0816; G02B 26/10

(57) ABSTRACT

A light deflector includes: a drive element configured to rotate a movable part having a reflection surface, about a rotation axis; an upper lid superposed on an upper surface of the drive element; and a lower lid superposed on a lower surface of the drive element. The upper lid and the lower lid oppose the upper surface and the lower surface of the drive element, respectively, with gaps that permit specified rotational movement of the movable part.

### CROSS REFERENCE TO RELATED APPLICATION

This application is a continuation of International Application No. PCT/JP2022/018605 filed on Apr. 22, 2022, entitled “LIGHT DEFLECTOR”, which claims priority under 35 U.S.C. Section 119 of Japanese Patent Application No. 2021-090474 filed on May 28, 2021, entitled “LIGHT DEFLECTOR”. The disclosures of the above applications are incorporated herein by reference.

### BACKGROUND OF THE INVENTION

### Field of the Invention

The present invention relates to a light deflector that rotates a reflection surface and deflects light.

### Description of Related Art

In recent years, by using micro electro mechanical system (MEMS) technology, drive elements that rotate a movable part have been developed. In this type of drive element, a reflection surface is located on the movable part, thereby allowing scanning to be performed at a predetermined deflection angle with light incident on the reflection surface. This type of drive element is installed in image projection devices such as head-up displays and head-mounted displays, for example. In addition, this type of drive element can also be used in laser radars that use laser beams to detect objects, etc.

For example, International Publication No. 2019/087919 describes a drive element of a type that rotates a movable part by a so-called tuning fork vibrator. Here, piezoelectric drivers are respectively placed on a pair of arm parts extending along a rotation axis. When AC voltages having phases different from each other by 180° (opposite phases) are applied to these piezoelectric drivers, respectively, the pair of arm parts expand and contract in directions opposite to each other. As a result, the movable part rotates about the rotation axis, and the reflection surface located on the movable part rotates accordingly.

In a light deflector including the above-described drive element, when an impact is applied from the outside, the drive element may be greatly displaced, resulting in unintended deformation of the drive element or damage to the drive element.

### SUMMARY OF THE INVENTION

A light deflector according to a first aspect of the present invention includes: a drive element configured to rotate a movable part having a reflection surface, about a rotation axis; an upper lid superposed on an upper surface of the drive element; and a lower lid superposed on a lower surface of the drive element. The upper lid and the lower lid oppose the upper surface and the lower surface of the drive element, respectively, with gaps that permit specified rotational movement of the movable part.

In the light deflector according to this aspect, the displacement of the drive element when an impact is applied from the outside is restricted within the range of the gap provided between the drive element and the upper lid, and is restricted within the range of the gap provided between the drive element and the lower lid. Therefore, the drive element is inhibited from being excessively displaced, so that the impact resistance of the drive element can be improved.

A light deflector according to a second aspect of the present invention includes: a drive element configured to rotate a movable part having a reflection surface, about a rotation axis; and an upper lid superposed on an upper surface of the drive element. The upper lid opposes the upper surface of the drive element with a gap that permits specified rotational movement of the movable part.

In the light deflector according to this aspect, the displacement of the drive element when an impact is applied from the outside is restricted within the range of the gap provided between the drive element and the upper lid. Therefore, the drive element is inhibited from being excessively displaced, so that the impact resistance of the drive element can be improved.

A light deflector according to a third aspect of the present invention includes: a drive element configured to rotate a movable part having a reflection surface, about a rotation axis; and a lower lid superposed on a lower surface of the drive element. The lower lid opposes the lower surface of the drive element with a gap that permits specified rotational movement of the movable part.

In the light deflector according to this aspect, the displacement of the drive element when an impact is applied from the outside is restricted within the range of the gap provided between the drive element and the lower lid. Therefore, the drive element is inhibited from being excessively displaced, so that the impact resistance of the drive element can be improved.

The effects and the significance of the present invention will be further clarified by the description of the embodiment below. However, the embodiment below is merely examples for implementing the present invention. The present invention is not limited to the description of the embodiment below in any way.

### BRIEF DESCRIPTION OF THE DRAWINGS

FIG. 1 is an exploded perspective view showing a configuration of a light deflector according to an embodiment;

FIG. 2A and FIG. 2B are respectively perspective views of an upper lid according to the embodiment as viewed from the upper side and the lower side;

FIG. 3A and FIG. 3B are respectively perspective views of a drive element according to the embodiment as viewed from the upper side and the lower side;

FIG. 4A and FIG. 4B are respectively a perspective view and a plan view of a lower lid according to the embodiment as viewed from the upper side;

FIG. 5 is a perspective view showing a configuration of the light deflector according to the embodiment in a state where assembly thereof is completed;

FIG. 6A and FIG. 6B are each a diagram schematically showing a cross-section obtained by cutting the light deflector according to the embodiment along C1-C2;

FIG. 7A is a perspective view of a lower lid according to Modification 1 as viewed from the upper side;

FIG. 7B is a diagram schematically showing a cross-section obtained by cutting a light deflector according to Modification 1 along C1-C2;

FIG. 8A is a perspective view of a lower lid according to Modification 2 as viewed from the upper side;

FIG. 8B is a diagram schematically showing a cross-section obtained by cutting a light deflector according to Modification 2 along C1-C2;

FIG. 9A is a perspective view of a lower lid according to a modification of Modification 2 as viewed from the upper side;

FIG. 9B is a diagram schematically showing a cross-section obtained by cutting a light deflector according to the modification of Modification 2 along C1-C2;

FIG. 10A and FIG. 10B are respectively a perspective view and a plan view of a lower lid according to Modification 3 as viewed from the upper side;

FIG. 11A is a perspective view showing a configuration of a light deflector according to Modification 4;

FIG. 11B is a diagram schematically showing a cross-section obtained by cutting the light deflector according to Modification 4 along C1-C2;

FIG. 12A is a diagram schematically showing a cross-section obtained by cutting a light deflector according to Modification 5 along C1-C2;

FIG. 12B is a diagram schematically showing a cross-section obtained by cutting a light deflector according to a modification of Modification 5 along C1-C2;

FIG. 13A and FIG. 13B are each a plan view of a movable part according to Modification 6 as viewed from the lower side;

FIG. 13C to FIG. 13E are each a plan view of opposing portions of electrodes according to Modification 6 as viewed from the upper side;

FIG. 14A is a perspective view of a drive element according to Modification 7 as viewed from the upper side;

FIG. 14B is a perspective view showing a configuration of a light deflector according to a modification of Modification 7;

FIG. 15A and FIG. 15B are respectively a perspective view of an upper lid according to Modification 8 as viewed from the lower side and a perspective view of a drive element according to Modification 8 as viewed from the upper side; and

FIG. 16A and FIG. 16B are perspective views showing configurations of light deflectors according to other modifications.

It should be noted that the drawings are solely for description and do not limit the scope of the present invention by any degree.

### DETAILED DESCRIPTION

Hereinafter, an embodiment of the present invention will be described with reference to the drawings. For convenience, in each drawing, X, Y, and Z axes that are orthogonal to each other are additionally shown. The Y-axis direction is a direction parallel to a rotation axis of a light deflector, and the Z-axis direction is a direction perpendicular to the upper surface (reflection surface) of a movable part in a neutral state. Hereinafter, the Z-axis positive direction is defined as an upward direction, and the Z-axis negative direction is defined as a downward direction.

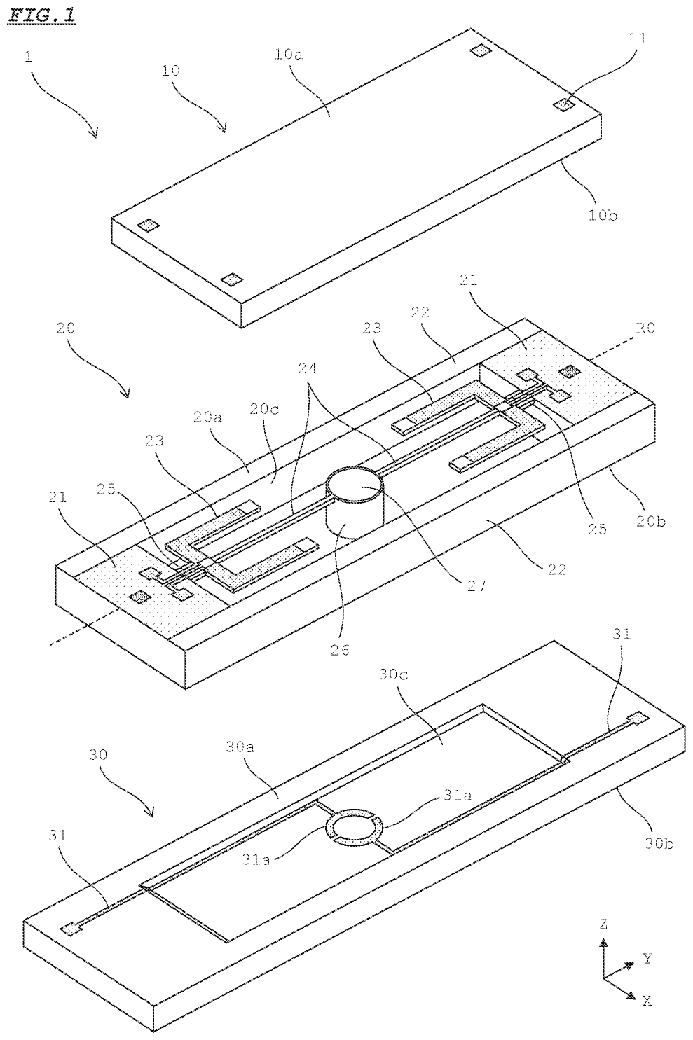

FIG. 1 is an exploded perspective view showing a configuration of a light deflector 1.

The light deflector 1 includes an upper lid 10, a drive element 20, and a lower lid 30.

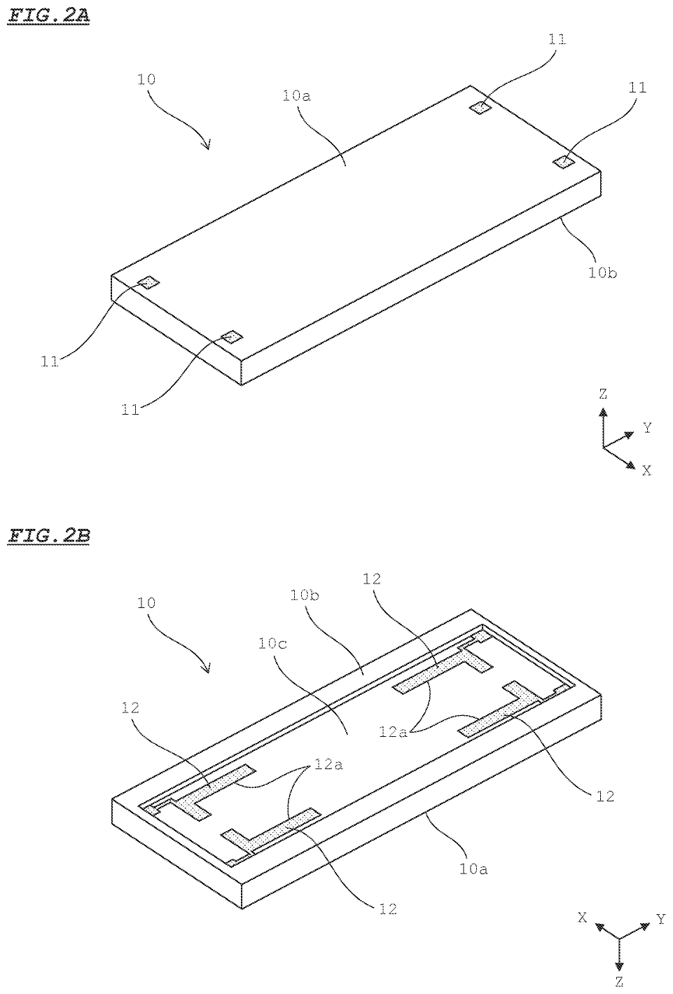

The upper lid 10 has a flat plate shape and is made of a light-transmitting material. The upper lid 10 is made of glass, for example. The upper lid 10 may be made of another light-transmitting material such as a resin. Terminals 11 for connecting electrodes 12 (see FIG. 2B) described later to the outside are installed at four corners of an upper surface 10a of the upper lid 10. The detailed configuration of the upper lid 10 will be described later with reference to FIG. 2A and FIG. 2B.

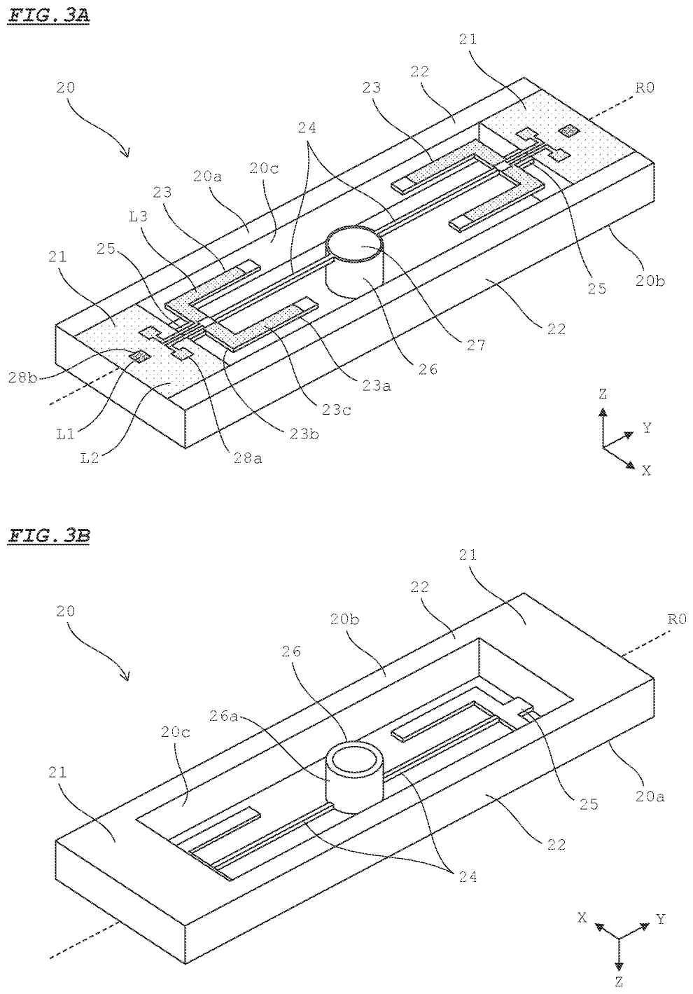

The drive element 20 includes two fixing parts 21, two frame parts 22, four drive parts 23, two first connection parts 24, two second connection parts 25, a movable part 26, and a reflection surface 27. The drive element 20 rotates the movable part 26 about a rotation axis R0. The movable part 26 and the reflection surface 27 are placed at the center of the drive element 20 in a plan view. The drive element 20 has a symmetrical shape in the X-axis direction and the Y-axis direction in a plan view. A pair of structures each including a fixing part 21, two drive parts 23, a first connection part 24, and a second connection part 25 are placed so as to be symmetrical about the center of the movable part 26 in a plan view. The thicknesses in the Z-axis direction of each fixing part 21, each frame part 22, and an outer peripheral portion (rib 26a described later) of the movable part 26 are larger than the thicknesses of each drive part 23, each first connection part 24, and each second connection part 25. The detailed configuration of the drive element 20 will be described later with reference to FIG. 3A and FIG. 3B.

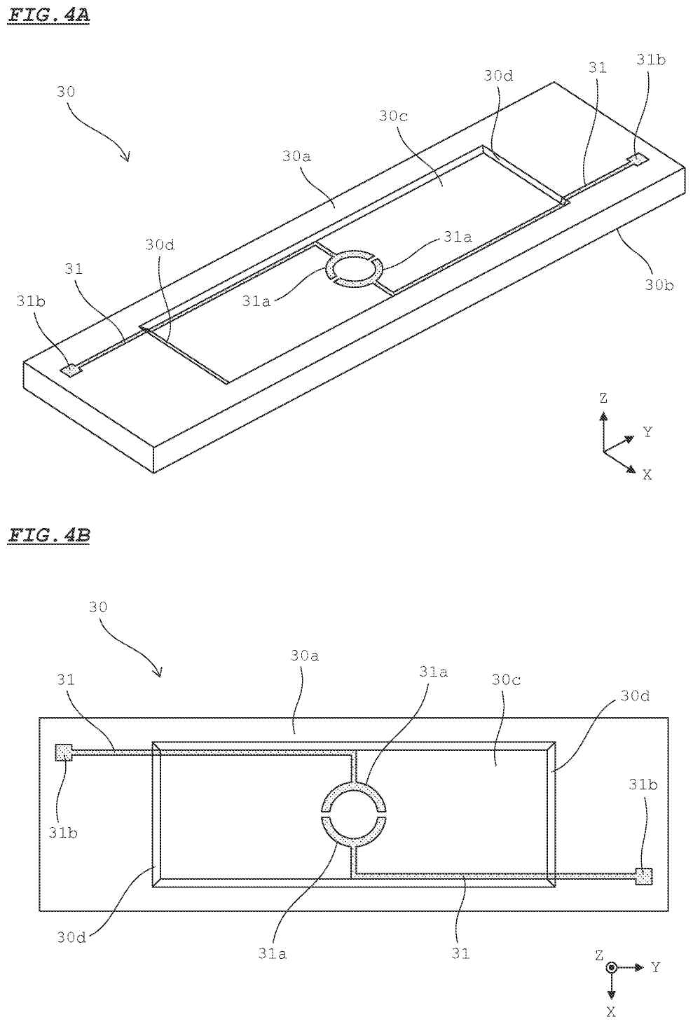

The lower lid 30 has a flat plate shape. A recess 30c having a rectangular shape in a plan view is formed at the center of an upper surface 30a of the lower lid 30. The bottom surface of the recess 30c is a flat surface parallel to the X-Y plane. Two electrodes 31 are placed on the upper surface 30a and the recess 30c of the lower lid 30 so as to be symmetrical about the center of the lower lid 30. Each electrode 31 extends from the center of the recess 30c to an end portion of the upper surface 30a, and a semicircular opposing portion 31a is formed in each electrode 31 near the center of the recess 30c. The detailed configuration of the lower lid 30 will be described later with reference to FIG. 4A and FIG. 4B.

FIG. 2A and FIG. 2B are respectively perspective views of the upper lid 10 as viewed from the upper side and the lower side.

The upper surface 10a and a lower surface 10b of the upper lid 10 are flat surfaces parallel to the X-Y plane. A recess 10c having a rectangular shape in a plan view is formed at the center of the lower surface 10b. The electrodes 12 are provided near the four corners of the recess 10c. The four electrodes 12 have shapes symmetrical with respect to each other in the X-axis direction and the Y-axis direction about the center of the recess 10c. The lower surface 10b of the upper lid 10 has a symmetrical shape in the X-axis direction and the Y-axis direction.

An L-shaped opposing portion 12a is formed in each electrode 12 on the center side of the recess 10c. The opposing portion 12a opposes the drive part 23 of the drive element 20 described later when the light deflector 1 is assembled, and is formed so as to have a larger surface area than at least an electrode for driving (upper electrode L3 described later) of the drive part 23. The electrodes 12 are connected to the terminals 11, which are placed on the upper surface 10a side, by through glass vias (TGV) near the corners of the recess 10c.

FIG. 3A and FIG. 3B are respectively perspective views of the drive element 20 as viewed from the upper side and the lower side.

The fixing parts 21, the frame parts 22, the drive parts 23, the first connection parts 24, the second connection parts 25, and the movable part 26 are integrally formed by an SOI substrate. In this case, each Si layer (active layer and base layer) of the SOI substrate is made of electrically-conductive low-resistance silicon. At this time, an intermediate oxide film (SiO₂ layer: not shown) located between each Si layer is removed by etching or the like such that the Si layers forming the fixing parts 21, the frame parts 22, the drive parts 23, the first connection parts 24, the second connection parts 25, and a portion of the movable part 26 other than the rib 26a and the Si layer (active layer and base layer) forming the rib 26a are electrically connected to each other, and the above portions are formed so as to have the same potential. The thicknesses of the SOI substrates forming the fixing parts 21, the frame parts 22, and the rib 26a of the movable parts 26 are the same. The thicknesses of the SOI substrates forming the drive parts 23, the first connection parts 24, the second connection parts 25, and the portion of the movable part 26 other than the rib 26a are preferably the same and are smaller than the thicknesses of the SOI substrates forming the fixing parts 21.

The frame parts 22 connect the two fixing parts 21 on the X-axis positive side and the X-axis negative side of the movable part 26. An opening 20c is formed at the center of the drive element 20 by the two fixing parts 21 and the two frame parts 22 so as to penetrate in the up-down direction. Each first connection part 24 and each second connection part 25 extend along the rotation axis R0. Each first connection part 24 connects the drive part 23 and the movable part 26, and each second connection part 25 connects the fixing part 21 and the drive part 23.

Each drive part 23 has an L-shape in a plan view and includes an arm portion 23a and a coupling portion 23b formed by the SOI substrate. The arm portion 23a extends in the Y-axis direction, and the coupling portion 23b extends in the X-axis direction. The drive part 23 is formed by forming a piezoelectric driver 23c on the upper surfaces of the arm portion 23a and the coupling portion 23b. Two drive parts 23 aligned in the X-axis direction are symmetrical about the rotation axis R0, and two drive parts 23 aligned in the Y-axis direction are symmetrical about the movable part 26.

Here, a lower electrode L1 and a piezoelectric layer L2 are stacked in the Z-axis positive direction on the upper surface of the SOI substrate (the arm portion 23a and the coupling portion 23b) of each drive part 23, the upper surface of the SOI substrate of each second connection part 25, and the upper surface of the SOI substrate of each fixing part 21. The lower electrode L1 and the piezoelectric layer L2 are placed so as to extend over these upper surfaces. The upper electrode L3 is further stacked on the upper surface of the piezoelectric layer L2 of each drive part 23 and the upper surface of the piezoelectric layer L2 of each second connection part 25. The upper electrode L3 is placed so as to extend over the upper surfaces of these piezoelectric layers L2.

The piezoelectric driver 23c of each drive part 23 has a structure in which: the arm portion 23a; the coupling portion 23b; and the lower electrode L1, the piezoelectric layer L2, and the upper electrode L3 which are placed on the arm portion 23a and the coupling portion 23b, are stacked. Each second connection part 25 is composed of the SOI substrate, and the lower electrode L1, the piezoelectric layer L2, and the upper electrode L3 placed on the SOI substrate. Each fixing part 21 is composed of the SOI substrate, and the lower electrode L1 and the piezoelectric layer L2 placed on the SOI substrate.

In each drive part 23 and each second connection part 25 in FIG. 3A, the upper electrode L3 placed at the uppermost surfaces thereof is shown. In each fixing part 21 in FIG. 3A, the piezoelectric layer L2 placed at the uppermost surface thereof is shown. The piezoelectric layer L2 is made of a piezoelectric material having a high piezoelectric constant such as lead zirconate titanate (PZT), for example. The lower electrode L1 and the upper electrode L3 are each made of a material having low electrical resistance and high heat resistance such as platinum (Pt) or gold (Au).

The upper electrode L3 of each drive part 23 and each second connection part 25 extends to the fixing part 21 and is connected to a terminal 28a for connecting the upper electrode L3 to the outside. The piezoelectric layer L2 of each fixing part 21 is cut out near the outer side in the Y-axis direction, and the lower electrode L1 is exposed upward through this cutout. The portion of the lower electrode L1 exposed upward is a terminal 28b for connecting the lower electrode L1 to the outside. Each drive part 23 is driven when a drive signal is supplied to the terminal 28a and the terminal 28b is connected to a ground. Accordingly, the movable part 26 rotates about the rotation axis R0 extending in the Y-axis direction.

The reflection surface 27 is formed by forming a reflection film made of a material having a high reflectance, on the surface on the Z-axis positive side of the movable part 26. The material forming the reflection film can be selected from among, for example, metals such as gold, silver, copper, and aluminum, metal compounds thereof, silicon dioxide, titanium dioxide, etc. The reflection film may be a dielectric multilayer film. In addition, the reflection surface 27 may be formed by polishing the upper surface of the movable part 26. The reflection surface 27 does not necessarily have to be flat, and may be a concave or convex curved surface. The reflection surface 27 reflects incident light in a direction corresponding to a deflection angle of the movable part 26. Accordingly, scanning is performed with the light (e.g., laser beam) incident on the reflection surface 27 as the movable part 26 rotates.

The rib 26a having a cylindrical shape whose interior is hollow is formed on the Z-axis negative side of the movable part 26. The outer diameter of the rib 26a is substantially equal to the outer diameter of the upper surface of the movable part 26. The thickness of the rib 26a in the X-Y plane direction is constant. The width of the rib 26a in the Z-axis direction is constant. The rigidity of the movable part 26 is increased by the rib 26a, so that strain of the upper surface of the movable part 26 and the reflection surface 27 is suppressed.

FIG. 4A and FIG. 4B are respectively a perspective view and a plan view of the lower lid 30 as viewed from the upper side.

The upper surface 30a and a lower surface 30b of the lower lid 30 are flat surfaces parallel to the X-Y plane. Four slopes 30d are formed at the outer periphery of the recess 30c of the lower lid 30 so as to connect the bottom surface of the recess 30c and the upper surface 30a. Each electrode 31 extends so as to straddle the slope 30d, which extends in the X-axis direction, in the Y-axis direction. On the outer side in the Y-axis direction of each electrode 31, a terminal 31b for connecting the electrode 31 to the outside is formed. The opposing portion 31a opposes the lower surface of the rib 26a of the drive element 20 when the light deflector 1 is assembled.

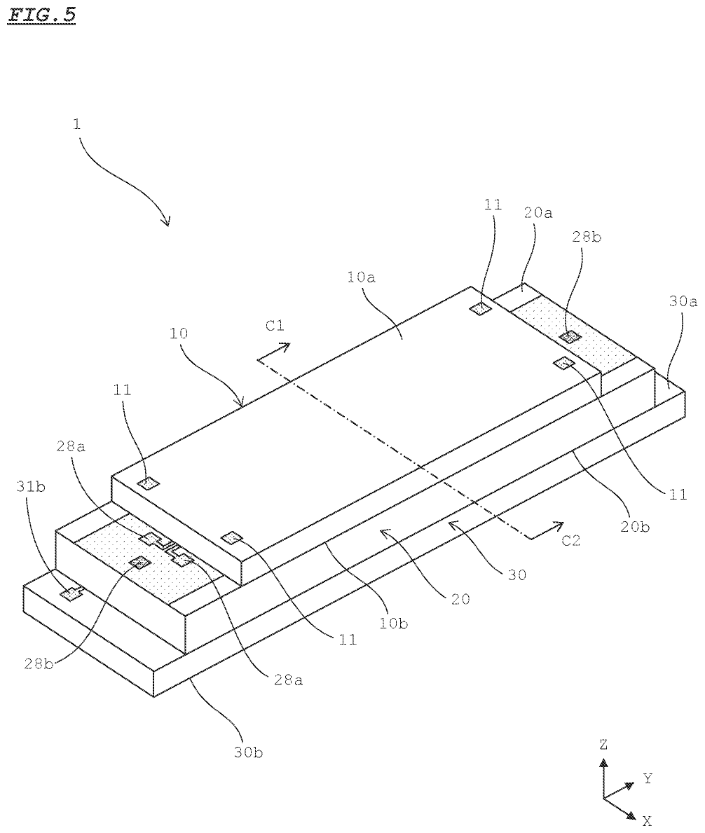

FIG. 5 is a perspective view showing a configuration of the light deflector 1 in a state where assembly thereof is completed.

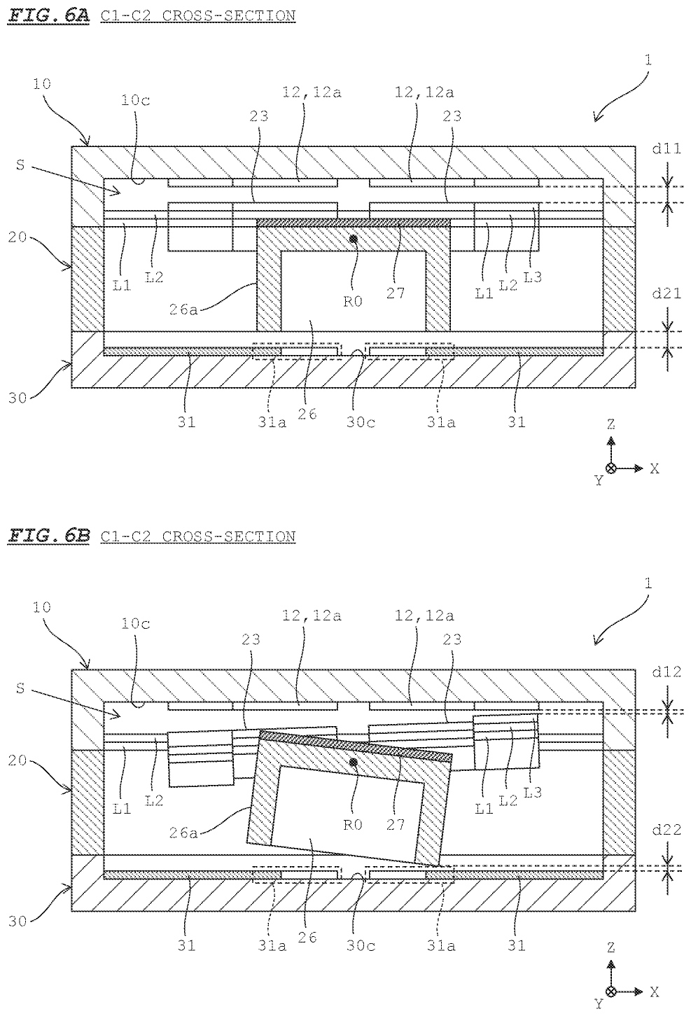

The lower surface 10b of the upper lid 10 is fixed hermetically to a region, surrounding the opening 20c, of an upper surface 20a of the drive element 20 by an adhesive such as frit glass or a resin, and the upper surface 30a of the lower lid 30 is fixed hermetically to a lower surface 20b of the drive element 20 by metal bonding (e.g., Au—Au or the like) or adhesive bonding (adhesion by frit glass, a resin, or the like). Accordingly, a closed space S (see FIG. 6A and FIG. 6B) is formed by the upper lid 10 and the lower lid 30. Thus, the assembly of the light deflector 1 is completed.

The closed space S is filled with, for example, a rare gas such as helium as a gas for suppressing deterioration of the drive element 20. In this case, in the above assembly process, the upper lid 10 and the lower lid 30 are installed on the drive element 20 in an environment filled with the rare gas. Accordingly, the closed space S sandwiched between the upper lid 10 and the lower lid 30 is filled with the rare gas such as helium.

Alternatively, the closed space S may be set to be in a vacuum state such that the air resistance is reduced and the drive element 20 can be more stably driven. In this case, in the above assembly process, the upper lid 10 and the lower lid 30 are installed on the drive element 20 in a vacuum environment. Accordingly, the closed space S sandwiched between the upper lid 10 and the lower lid 30 becomes vacuum.

In the assembled state in FIG. 5, the terminals 28a and 28b formed on the upper surface 20a of the drive element 20 are open upward. The terminals 28a and 28b are connected to an external circuit in order to drive the piezoelectric drivers 23c (see FIG. 3A) of the four drive parts 23. A sinusoidal drive signal is applied to each terminal 28a (upper electrode L3), and each terminal 28b is connected to the ground. Accordingly, each of the piezoelectric layers L2 of the four drive parts 23 expands and contracts.

At this time, drive signals are applied to the piezoelectric layers L2 of the drive parts 23 on the X-axis positive side and the piezoelectric layers L2 of the drive parts 23 on the X-axis negative in phases opposite to each other, and drive signals are applied to the piezoelectric layers L2 of the two drive parts 23 opposing each other in the Y-axis direction, in the same phase. Accordingly, the drive parts 23 on the X-axis positive side and the drive parts 23 on the X-axis negative repeatedly deform in directions opposite to each other, the movable part 26 rotates around the rotation axis R0, and the reflection surface 27 rotates at a predetermined deflection angle.

When the light deflector 1 is used, light is incident on the light deflector 1 in the Z-axis negative direction. The light incident on the light deflector 1 passes through the upper lid 10 to the reflection surface 27, is reflected by the reflection surface 27, then passes through the upper lid 10 again, and travels from the light deflector 1 to a target region. Accordingly, the target region can be scanned with the light.

FIG. 6A and FIG. 6B are each a diagram schematically showing a cross-section obtained by cutting the light deflector 1 along C1-C2 shown in FIG. 5. FIG. 6A shows a neutral state of each drive part 23 and the movable part 26, and FIG. 6B shows a state where the drive width of each drive part 23 and the rotation angle of the movable part 26 become maximum in specified movement.

As shown in FIG. 6A, when each drive part 23 and the movable part 26 are in the neutral state, the opposing portion 12a of each electrode 12 installed in the recess 10c of the upper lid 10 and the upper surface of each drive part 23 oppose each other with a gap d11 in the up-down direction. In addition, the opposing portion 31a of each electrode 31 installed in the recess 30c of the lower lid 30 and the lower end of the rib 26a of the movable part 26 oppose each other with a gap d21 in the up-down direction. The gap d11 is a gap that permits specified drive movement of each drive part 23, and the gap d21 is a gap that permits specified rotational movement of the movable part 26. The specified drive movement of each drive part 23 refers to the movement of the drive part 23 when the drive part 23 is driven in a target drive range, and the specified rotational movement of the movable part 26 refers to the movement of the movable part 26 and the reflection surface 27 to be rotated in a target rotation range.

The gaps d11 and d21 are set such that the drive element 20 can be restricted from being displaced so greatly by an impact or the like that the drive element 20 can be damaged. That is, the gaps d11 and d21 are set to sizes that allow the upper lid 10 and the lower lid 30 to restrict a to-be-displaced portion (e.g., each drive part 23 or the movable part 26) of the drive element 20 from being displaced more greatly than during normal operation, thereby suppressing damage to the drive element 20.

When drive of each drive part 23 is started, the drive part 23 repeatedly vibrates in the up-down direction. At this time, the distal end (end portion on the side opposite to the coupling portion 23b) of the arm portion 23a of each drive part 23 is most greatly displaced. When the movable part 26 is rotated by the drive of each drive part 23, the movable part 26 repeatedly rotates around the rotation axis R0. At this time, the lower end of the rib 26a of the movable part 26 is displaced in the up-down direction.

As shown in FIG. 6B, when the drive width of each drive part 23 and the rotation angle of the movable part 26 become maximum in the specified movement, the opposing portion 12a of each electrode 12 and the upper surface of each drive part 23 oppose each other with a gap d12 in the up-down direction. In addition, the opposing portion 31a of each electrode 31 and the lower end of the rib 26a of the movable part 26 oppose each other with a gap d22 in the up-down direction. The gap d12 is set to be as small as possible such that each opposing portion 12a and the upper surface of each drive part 23 do not come into contact with each other during the specified drive movement. In addition, the gap d22 is set to be as small as possible such that each opposing portion 31a and the lower end of the rib 26a do not come into contact with each other during the specified rotational movement.

FIG. 6B shows the case where each drive part 23 and the movable part 26 are driven in a “reverse-phase mode” in which the drive directions thereof are different from each other, but each drive part 23 and the movable part 26 may be driven in an “in-phase mode” in which the drive directions thereof coincide with each other.

Here, detection of the drive of each drive part 23 using each electrode 12 and detection of the rotation of the movable part 26 using each electrode 31 will be described.

As shown in FIG. 5, each terminal 11 formed on the upper surface 10a of the upper lid 10 and each terminal 31b formed on the upper surface 30a of the lower lid 30 are open upward, and the terminals 11 and 31b are connected to an external circuit. In addition, the Si layer, of the drive element 20, made of low-resistance silicon is connected to the ground.

Accordingly, the capacitance between each electrode 12 and the Si layer of the drive element 20 changes in accordance with the size of the gap between the upper surface of each drive part 23 and each opposing portion 12a. Therefore, the drive position of the drive part 23 can be detected by detecting this capacitance by the external circuit. Similarly, the capacitance between each electrode 31 and the Si layer of the drive element 20 changes in accordance with the size of the gap between the lower surface of the rib 26a and each opposing portion 31a. Therefore, the rotational position of the movable part 26 can be detected by detecting this capacitance by the external circuit.

Since the four electrodes 12 are placed in the upper lid 10 so as to oppose the four drive parts 23 as shown in FIG. 2B, the drive positions of the four drive parts 23 can be detected individually by detecting the capacitances based on the four electrodes 12.

Since two electrodes 12 are placed so as to oppose two drive parts 23 aligned in the X-axis direction, the drive of the two drive parts 23 driven in phases opposite to each other can be accurately detected by detecting the capacitances based on these two electrodes 12. That is, when the two drive parts 23 aligned in the X-axis direction are driven, as the capacitance of one electrode 12 increases, the capacitance of the other electrode 12 decreases. Therefore, the drive position of each drive part 23 can be accurately detected on the basis of the balance between the capacitances of the two electrodes 12 aligned in the X-axis direction.

Since the two opposing portions 31a are placed in the lower lid 30 so as to oppose an arc portion on the X-axis positive side and an arc portion on the X-axis negative of the rib 26a as shown in FIG. 4B, the rotational position of the movable part 26 rotating about the rotation axis R0 can be accurately detected by detecting the capacitances based on the two electrodes 31. That is, when the movable part 26 rotates, as the capacitance of one electrode 31 increases, the capacitance of the other electrode 31 decreases. Therefore, the rotational position of the movable part 26 can be accurately detected on the basis of the balance between the capacitances of the two electrodes 31.

Each detection result is used for feedback control of controlling each drive part 23 and the movable part 26 into a target drive state. For example, the detection result based on each electrode 12 can be referenced such that the amplitude amount and the amplitude period of each drive part 23 become target values. In addition, the detection result based on each electrode 31 can be referenced such that the rotation amount and the rotation period of the movable part 26 become target values.

Furthermore, an operation abnormality or an operation failure of the drive element 20 can be determined from the detection result based on each electrode 12 and the detection result based on each electrode 31. For example, if it is determined from the detection result based on each electrode 12 that each drive part 23 is moving properly, but it is determined from the detection result based on each electrode 31 that the rotation of the movable part 26 is not proper, it can be determined that an operation abnormality has occurred in the drive element 20. In this case, a control circuit that controls the operation of the light deflector 1 can perform control of stopping the operation of the light deflector 1 and notifying that an operation abnormality has occurred in the light deflector 1.

### Effects of Embodiment

According to the present embodiment, the following effects can be achieved.

The upper lid 10 is superposed on the upper surface 20a of the drive element 20, and the lower lid 30 is superposed on the lower surface 20b of the drive element 20. The upper lid 10 and the lower lid 30 oppose the upper surface 20a and the lower surface 20b of the drive element 20, respectively, with gaps that permit the specified rotational movement of the movable part 26. With this configuration, the displacement of the drive element 20 when an impact is applied from the outside is restricted within the range of the gap provided between the drive element 20 and the upper lid 10, and is restricted within the range of the gap provided between the drive element 20 and the lower lid 30. Accordingly, each drive part 23 and the movable part 26 can be inhibited from being excessively displaced, so that damage to the drive element 20, such as cutting off of the first connection part 24 and the second connection part 25 due to excessive displacement thereof, can be avoided. Thus, the drive element 20 can be inhibited from being excessively displaced, so that the impact resistance of the drive element 20 can be improved.

The rib 26a is formed on the lower surface of the movable part 26, and the lower lid 30 opposes the lower surface of the rib 26a with the gap d21 which permits the specified rotational movement of the movable part 26 (see FIG. 6A). When the rib 26a is formed on the lower surface of the movable part 26, the strength of the movable part 26 is increased. Accordingly, even when the movable part 26 rotates, strain of the movable part 26 and the reflection surface 27 is suppressed, so that light can be reflected properly by the reflection surface 27 in accordance with the rotation of the movable part 26. Since the displacement of the movable part 26 is restricted within the range of the gap d21 provided between the rib 26a and the lower lid 30, the movable part 26 can be inhibited from being excessively displaced.

The upper lid 10 is made of a light-transmitting material, and covers the upper surface 20a (region surrounding the opening 20c) of the drive element 20 without any gap, and the lower lid 30 covers the lower surface 20b (region surrounding the opening 20c) of the drive element 20 without any gap. The space sandwiched between the upper lid 10 and the lower lid 30 is the closed space S. Accordingly, entry of dust, etc., into the closed space S can be suppressed, so that proper movement of each drive part 23 and the movable part 26 can be maintained.

At this time, the closed space S is filled with, for example, a gas for suppressing deterioration of the drive element 20. For example, the closed space S is filled with a rare gas such as helium as the gas for suppressing deterioration of the drive element 20. Accordingly, the viscous resistance of the closed space S becomes lower than that in the case where the closed space S is filled with air, thereby making it possible to increase resonance sharpness Q. As a result, the voltage applied to each drive part 23 can be set lower to achieve the desired drive, so that the driving efficiency can be set higher. In addition, since the rare gas such as helium rarely reacts with PZT (piezoelectric body), deterioration of the piezoelectric layer L2 can be suppressed. Therefore, power saving can be realized, and deterioration of the piezoelectric layer L2 can be suppressed to improve long-term reliability.

Alternatively, the closed space S may be in a vacuum state where the air is removed therefrom. In this case as well, the viscous resistance of the closed space S becomes lower than that in the case where the closed space S is filled with air, thereby making it possible to increase the resonance sharpness Q. As a result, the voltage applied to each drive part 23 can be set lower to achieve the desired drive, so that the driving efficiency can be set higher. In addition, the reaction of moisture and oxygen in the air with the PZT in the piezoelectric layer L2 can be suppressed. Therefore, in this case as well, power saving can be realized, and deterioration of the piezoelectric layer L2 can be suppressed to improve long-term reliability.

First electrodes (electrodes 12) are formed on the lower surface (recess 10c) of the upper lid 10 so as to oppose the displacement portions (drive parts 23) of the drive element 20 during rotational movement of the drive element 20. With this configuration, the displacement state of each drive part 23 can be detected by a change in the capacitance between each electrode 12 and each drive part 23. Accordingly, for example, feedback control of adjusting the drive signal applied to each drive part 23 can be performed on the basis of the detection result of the displacement state of each drive part 23 such that each drive part 23 is driven as desired. In addition, in the case where the displacement state is detected using each electrode as described above, the influence of temperature can be suppressed and the displacement state can be detected properly as compared to the case where displacement is detected using a piezoelectric body.

The first electrodes (electrodes 12) are placed such that the rotation axis R0 is interposed therebetween. That is, in the upper lid 10, the opposing portions 12a of two electrodes 12 are placed so as to oppose two drive parts 23 placed such that the rotation axis R0 is interposed therebetween, and the two opposing portions 12a are placed such that the rotation axis R0 is interposed therebetween. With this configuration, the drive state of each drive part 23 can be accurately detected.

Second electrodes (electrodes 31) are formed on the upper surface (recess 30c) of the lower lid 30 so as to oppose the displacement portion (rib 26a) of the drive element 20 during rotational movement of the drive element 20. With this configuration, the displacement state of the rib 26a can be detected by a change in the capacitance between each electrode 31 and the rib 26a. Accordingly, for example, feedback control of adjusting the drive signal applied to each drive part 23 can be performed on the basis of the detection result of the displacement state of the rib 26a such that the movable part 26 rotates as desired. Also, in this case as well, the influence of temperature can be suppressed and the displacement state can be detected properly as compared to the case where displacement is detected using a piezoelectric body.

The second electrodes (electrodes 31) oppose the lower surface of the movable part 26 and are separated in a direction perpendicular to the rotation axis R0. That is, the two opposing portions 31a of the electrodes 31 are placed in the lower lid 30 so as to oppose the rib 26a, and oppose the arc shape on the X-axis positive side of the rib 26a and the arc shape on the X-axis negative side of the rib 26a, respectively. With this configuration, the rotation state of the movable part 26 can be accurately detected.

In the case where both of the electrodes 12 and 31 are provided as in the present embodiment, by comparing the displacement state of each drive part 23 based on each electrode 12 and the displacement state of the rib 26a based on each electrode 31, it can be determined whether abnormalities have occurred in the drive of each drive part 23 and the rotation of the movable part 26 as described above.

Also, by combining conventional feedback control using a piezoelectric effect and feedback control based on changes in capacitance in the present embodiment, even more redundant feedback control can be realized.

The drive element 20 includes the pair of arm portions 23a extending in a direction parallel to the rotation axis R0 with the rotation axis R0 interposed therebetween on the Y-axis positive side and the Y-axis negative side of the movable part 26, the coupling portions 23b connecting the pair of arm portions 23a to the connection part (the first connection part 24 and the second connection part 25), and the piezoelectric drivers 23c placed on the arm portions 23a and the coupling portions 23b. In the case where the drive element 20 is configured as described above, when an impact is applied to the light deflector 1, excessive stress may be applied to the first connection part 24 and the second connection part 25, and the first connection part 24 and the second connection part 25 may be cut off. However, if the displacement portions of the drive element 20 are inhibited from being excessively displaced as described above, excessive stress can be inhibited from being applied to the first connection part 24 and the second connection part 25, so that damage to the first connection part 24 and the second connection part 25 can be suppressed.

### Modification 1

In the above embodiment, excessive displacement of the movable part 26 in the up-down direction is restricted by providing the gap that permits the specified rotational movement of the movable part 26, between the lower surface of the rib 26a of the movable part 26 and the lower lid 30. However, excessive displacement of the movable part 26 in a horizontal direction may be restricted by further providing a wall surface to the lower lid 30.

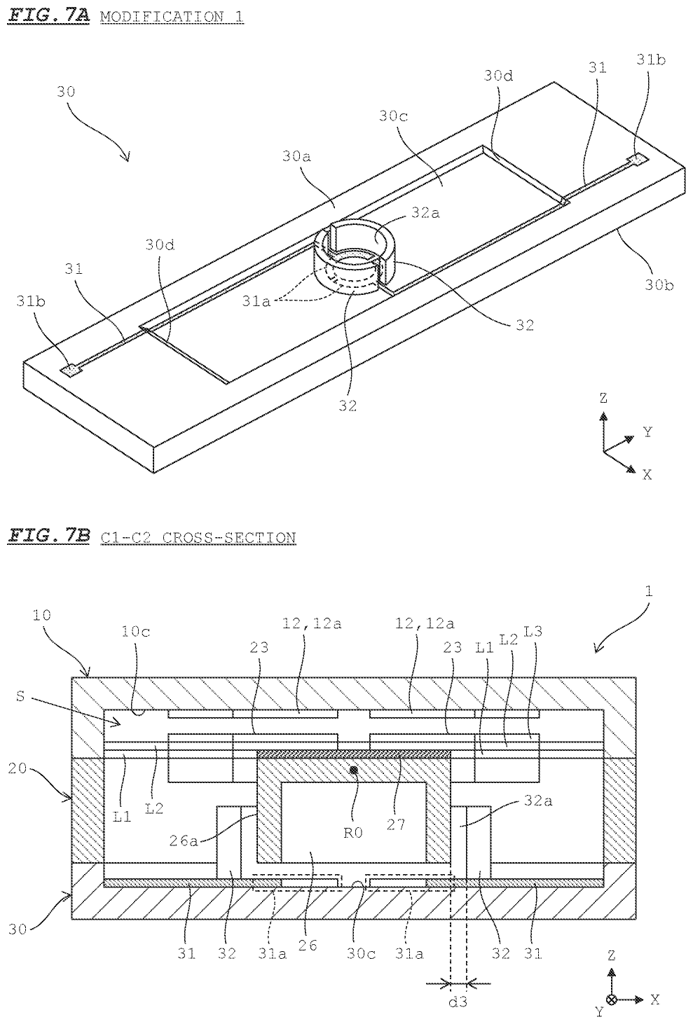

FIG. 7A is a perspective view of a lower lid 30 according to Modification 1 as viewed from the upper side.

In Modification 1, compared to the above embodiment, a wall portion 32 is formed near the center of the recess 30c so as to project upward. The wall portion 32 is formed outside the opposing portions 31a of the electrodes 31, and has a cylindrical shape whose interior is hollow. Slits are formed in an end portion on the X-axis positive side and an end portion on the X-axis negative side of the wall portion 32 so as to penetrate the wall portion 32 in the X-axis direction. Each electrode 31 extends from the opposing portion 31a to the terminal 31b through the slit.

FIG. 7B is a diagram schematically showing a cross-section obtained by cutting a light deflector 1 according to Modification 1 along C1-C2 shown FIG. 5.

When each drive part 23 and the movable part 26 are in the neutral state, the outer surface of the rib 26a of the movable part 26 and a wall surface 32a which is the inner surface of the wall portion 32 oppose each other with a gap d3 in the horizontal direction. The gap d3 is a gap that permits the specified rotational movement of the movable part 26. That is, the wall surface 32a opposes the outer surface of the rib 26a with the gap d3 which permits the specified rotational movement of the movable part 26.

According to Modification 1, the displacement of the movable part 26 is restricted within the range of the gap d3 provided between the outer surface of the rib 26a and the wall surface 32a, so that the movable part 26 can be inhibited from being excessively displaced in the direction in which the outer surface of the rib 26a and the wall surface 32a oppose each other. As a result, excessive displacement in the horizontal direction is restricted, and impact resistance can be improved not only in the vertical direction but also in the horizontal direction.

### Modification 2

In Modification 1 described above, the wall surface 32a which opposes the outer surface of the rib 26a is formed by the wall portion 32 provided outside the opposing portions 31a of the electrodes 31, but the wall surface is not limited to being formed by the wall portion 32.

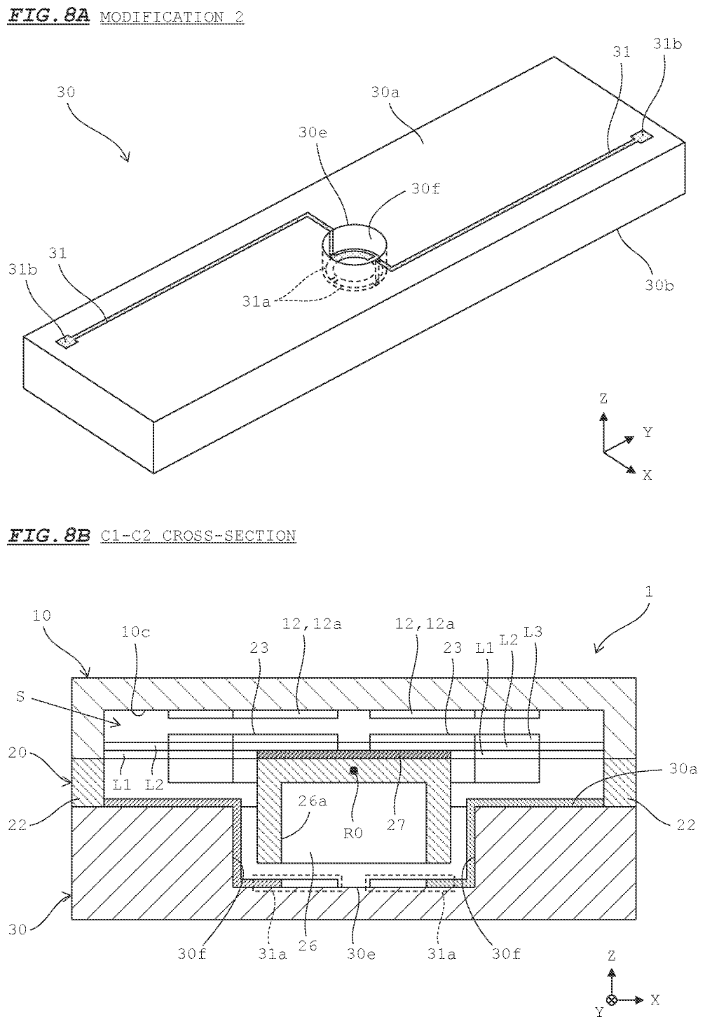

FIG. 8A is a perspective view of a lower lid 30 according to Modification 2 as viewed from the upper side.

In Modification 2, compared to the above embodiment, the recess 30c is omitted, and the height position of the upper surface 30a is shifted in the Z-axis positive direction, thereby increasing the thickness of the lower lid 30. A recess 30e is formed at the center of the lower lid 30 so as to be recessed downward. The bottom surface of the recess 30e is at the same height as that of the recess 30c of the above embodiment, and is parallel to the X-Y plane. The opposing portions 31a of the electrodes 31 are placed on the bottom surface of the recess 30e as in the above embodiment. A wall surface 30f having a cylindrical side surface shape is formed on a side surface portion of the recess 30e. Each electrode 31 extends from the opposing portion 31a to the terminal 31b through the wall surface 30f.

FIG. 8B is a diagram schematically showing a cross-section obtained by cutting a light deflector 1 according to Modification 2 along C1-C2 shown in FIG. 5.

In this case, the thickness of each frame part 22 which is an end portion in the X-axis direction of the drive element 20 and the thickness of each fixing part 21 which is an end portion in the Y-axis direction of the drive element 20 are set smaller than in the above embodiment, and the distance between the lower surface of the rib 26a and the lower surface of the recess 30e is set to be the same as in the above embodiment.

In Modification 2 as well, as in Modification 1, the displacement of the movable part 26 is restricted within the range of the gap provided between the outer surface of the rib 26a and the wall surface 30f, so that the movable part 26 can be inhibited from being excessively displaced in a direction in which the outer surface of the rib 26a and the wall surface 30f oppose each other.

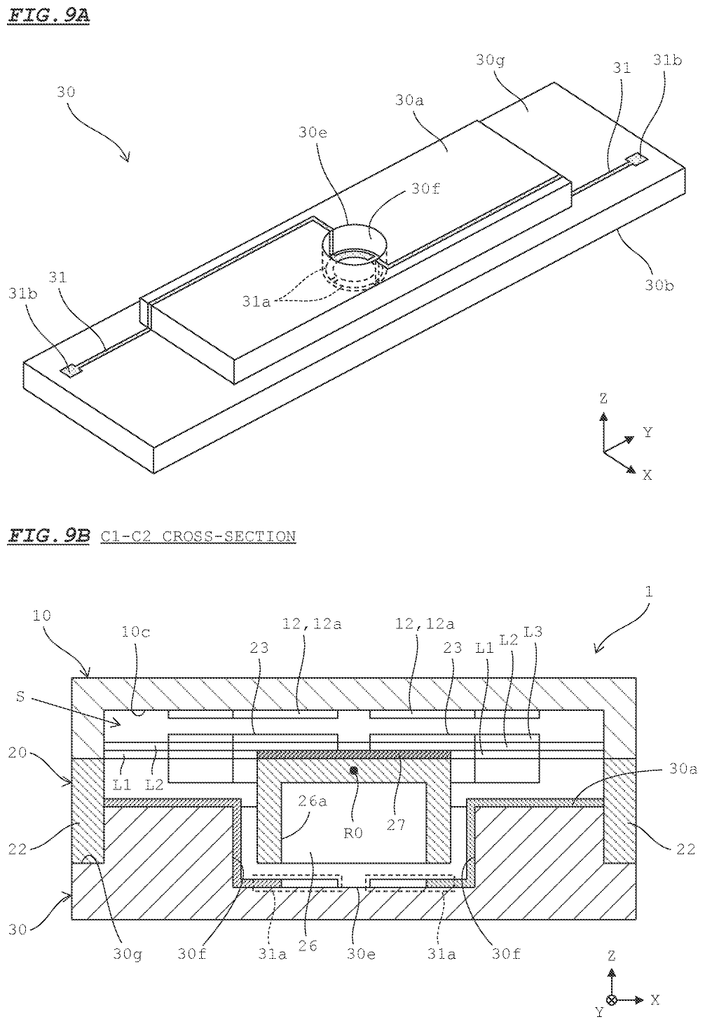

In FIG. 8A and FIG. 8B, the thickness of each frame part 22 which is an end portion in the X-axis direction of the drive element 20 and the thickness of each fixing part 21 which is an end portion in the Y-axis direction of the drive element 20 are set smaller than in the above embodiment, but may be set to be the same as in the above embodiment. In this case, as shown in FIG. 9A and FIG. 9B, a portion surrounding the recess 30e is the upper surface 30a as in FIG. 8A and FIG. 8B, and an upper surface 30g lower than the upper surface 30a is formed around the upper surface 30a. The height position of the upper surface 30g is the same as that of the upper surface 30a of the above embodiment, and the lower surface of each frame part 22 and the lower surface of each fixing part 21 are located on the upper surface 30g. Thus, as in the above embodiment, the thicknesses of each fixing part 21, each frame part 22, and the movable part 26 can be the same, so that the production process of the drive element 20 can be simplified.

### Modification 3

In Modification 1 described above, an electrode may be further provided on the wall surface 32a.

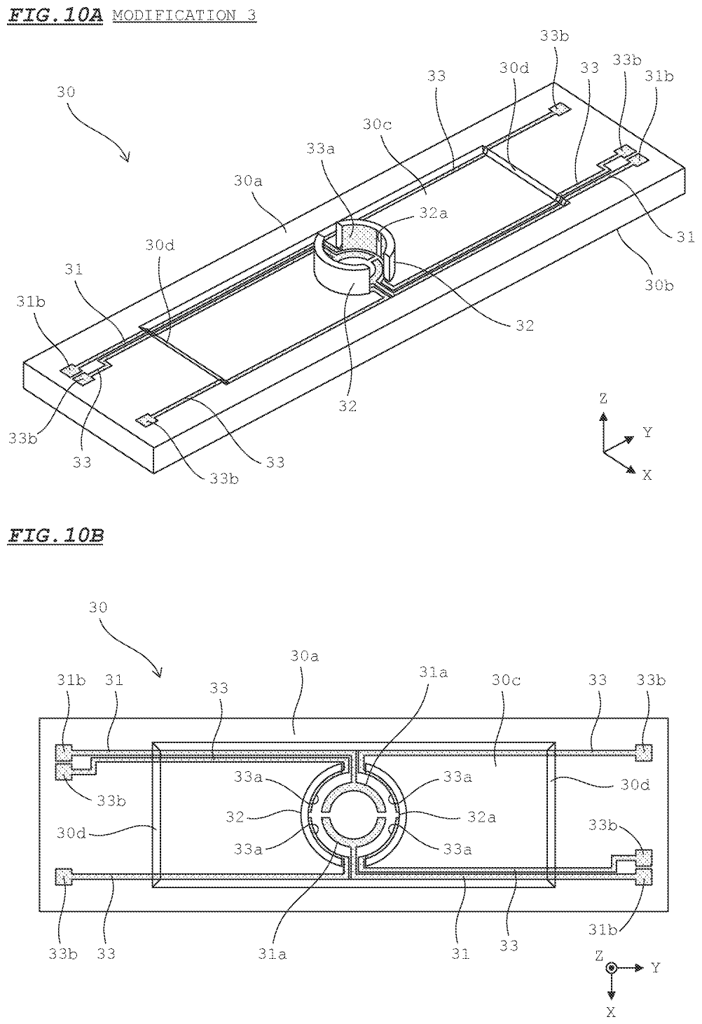

FIG. 10A and FIG. 10B are respectively a perspective view and a plan view of a lower lid 30 according to Modification 3 as viewed from the upper side.

In Modification 3, compared to Modification 1 described above, four electrodes 33 are further placed. An opposing portion 33a is provided at an end portion in the inward direction of each electrode 33, and a terminal 33b is provided at an end portion in the outward direction of each electrode 33. The opposing portion 33a is installed on the wall surface 32a which is the inner surface of the wall portion 32. The opposing portions 33a of the four electrodes 33 are placed so as to be separated in a direction perpendicular to the rotation axis R0 and a direction parallel to the rotation axis R0.

According to Modification 3, the displacement state in the horizontal direction of the rib 26a can be detected by a change in the capacitance between each electrode 33 and the rib 26a.

### Modification 4

In the above embodiment, the upper lid 10 covers the upper surface 20a of the drive element 20 without any gap, but, instead, an opening 10d may be formed in the upper lid 10 at a position above the movable part 26.

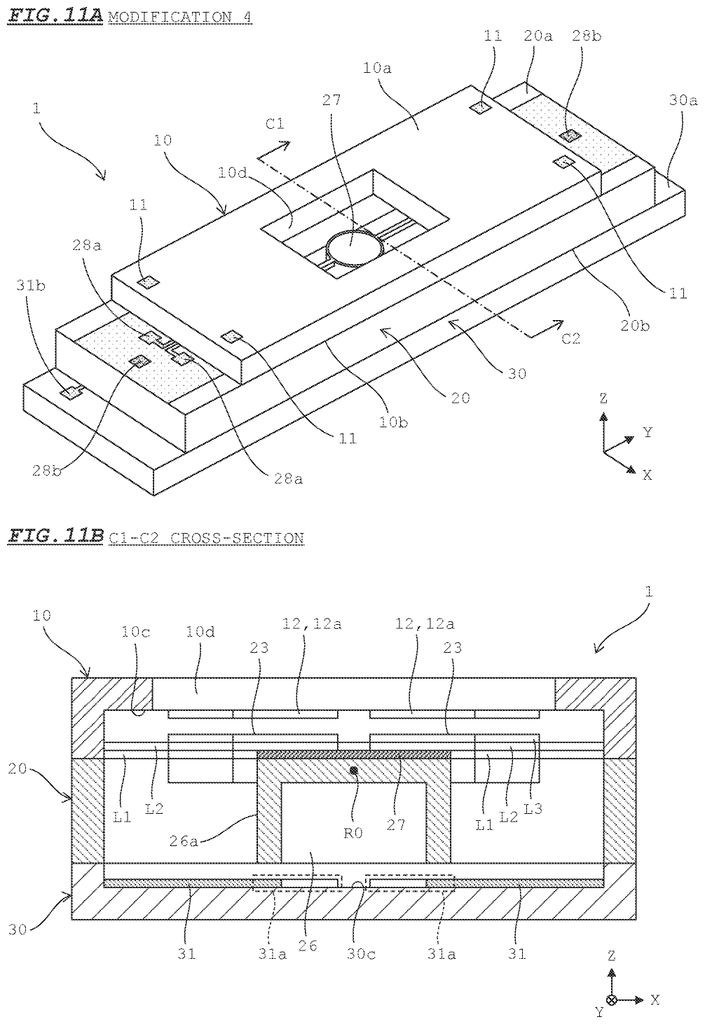

FIG. 11A is a perspective view showing a configuration of a light deflector 1 according to Modification 4. FIG. 11B is a diagram schematically showing a cross-section obtained by cutting the light deflector 1 according to Modification 4 along C1-C2 shown in FIG. 11A.

In Modification 4, compared to the above embodiment, the upper lid 10 is made of a material that does not transmit light (e.g., Si substrate), and the opening 10d is formed at the center of the upper lid 10 so as to penetrate the upper lid 10 in the up-down direction. In this case, unlike the above embodiment, the closed space S based on the upper lid 10 and the lower lid 30 is not formed. The electrodes 12 installed in the recess 10c of the upper lid 10 and the terminals 11 installed on the upper surface 10a of the upper lid 10 are connected by through silicon vias (TSV).

Light incident on the light deflector 1 passes through the opening 10d, is reflected by the reflection surface 27, then passes through the opening 10d again, and travels from the light deflector 1 to the target region.

According to Modification 4, since the opening 10d is provided, light incident from the Z-axis positive side of the upper lid 10 can be efficiently guided to the reflection surface 27, and light reflected by the reflection surface 27 can be efficiently guided to the Z-axis positive side of the upper lid 10. In addition, since the upper lid 10 is made of an Si substrate, lower cost and a simpler formation process for the upper lid 10 can be realized as compared to the case where the upper lid 10 is made of a light-transmitting material. However, in Modification 4, the closed space S shown in the above embodiment is not formed, and thus, to realize power saving and suppression of deterioration of the piezoelectric layer L2, it is preferable to provide the closed space S as in the above embodiment.

### Modification 5

In the above embodiment, a center portion of the upper lid 10 has a plate shape parallel to the X-Y plane, but this portion may be formed so as to be inclined.

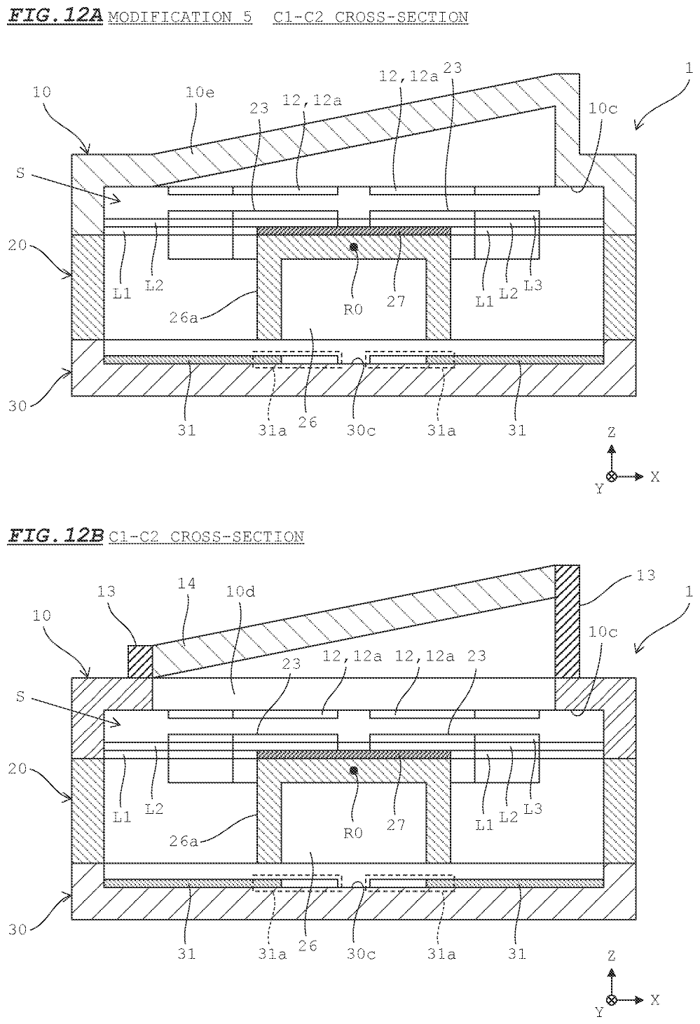

FIG. 12A is a diagram schematically showing a cross-section obtained by cutting a light deflector 1 according to Modification 5 along C1-C2 shown in FIG. 5.

In Modification 5, compared to the above embodiment, an inclined portion 10e is formed in the center portion of the upper lid 10. The upper surface and the lower surface of the inclined portion 10e are parallel to each other. The inclined portion 10e is inclined with respect to the rotation axis R0 at a position above the movable part 26 and the reflection surface 27. The inclined portion 10e is a part of the upper lid 10, and is formed by processing the light-transmitting material forming the upper lid 10. The angle of the inclined portion 10e with respect to the X-Y plane is set such that light reflected by the surface of the inclined portion 10e is not projected to the target region.

According to Modification 5, when light incident on the light deflector 1 from the Z-axis positive side of the upper lid 10 is guided to the target region by the reflection surface 27, light (stray light) reflected by the surface of the upper lid 10 can be inhibited from being applied to the target region.

In the case where the opening 10d is provided in the upper lid 10 as in Modification 4 shown in FIG. 11A and FIG. 11B, an inclined portion 14 may be provided above the opening 10d.

FIG. 12B is a diagram schematically showing a cross-section obtained by cutting a light deflector 1 in this case along C1-C2 shown in FIG. 5.

In this modification, compared to Modification 4, a wall portion 13 is provided around the opening 10d, and the inclined portion 14 is installed at the wall portion 13. The inclined portion 14 is made of the same light-transmitting material as the upper lid 10 of the above embodiment, and is formed in the same shape as the inclined portion 10e in FIG. 12A. During assembly of the light deflector 1, the upper lid 10, the wall portion 13, and the inclined portion 14 are installed in an environment filled with a rare gas such as helium or in a vacuum environment. Accordingly, the closed space S is formed by the upper lid 10, the wall portion 13, the inclined portion 14, and the lower lid 30, and is brought into a state of being filled with a rare gas such as helium or into a vacuum state. Therefore, in the modification shown in FIG. 12B as well, the same effects as in the case of FIG. 12A are achieved.

### Modification 6

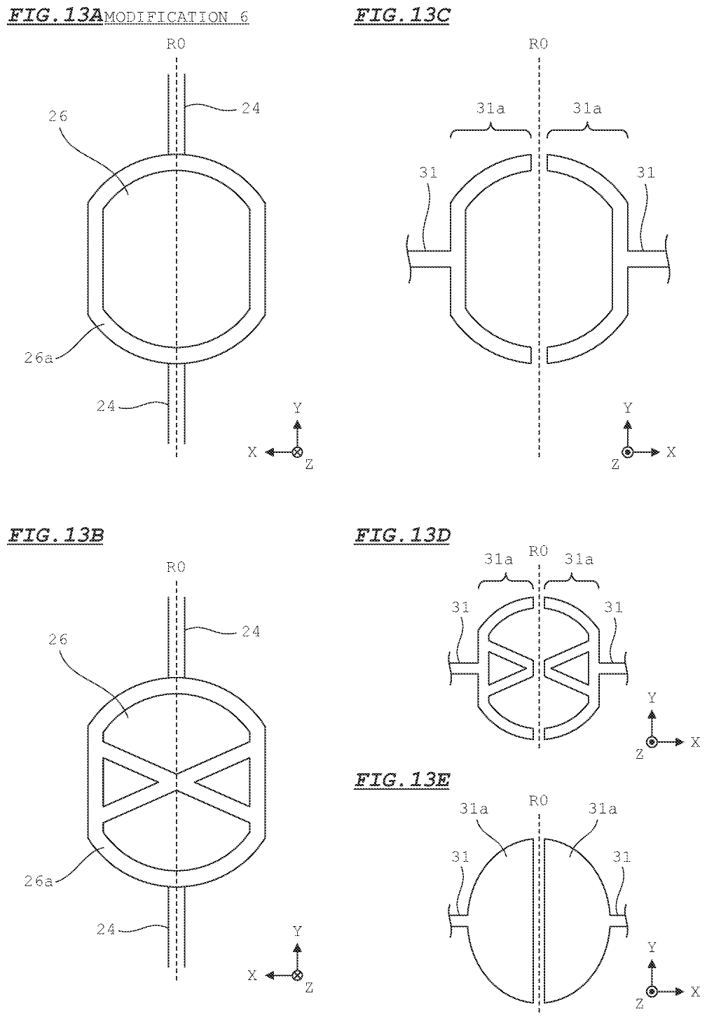

In the above embodiment, the rib 26a having a cylindrical shape is formed on the lower surface side of the movable part 26 so as to project downward, but the shape of the rib 26a is not limited thereto. For example, the rib 26a may have a shape as shown in FIG. 13A or FIG. 13B. Also, in the above embodiment, the opposing portion 31a of each electrode 31 placed in the lower lid 30 has a semicircular shape, but the shape of the opposing portion 31a is not limited thereto. For example, the opposing portion 31a may be shaped as shown in FIG. 13C to FIG. 13E so as to match the shape of the rib 26a.

FIG. 13A and FIG. 13B are each a plan view of the movable part 26 as seen from the lower side.

In FIG. 13A, compared to the above embodiment, end portions on the X-axis positive and X-axis negative sides of the rib 26a are parallel to the Y-axis direction. In FIG. 13B, ribs are formed so as to intersect each other at the center with respect to the shape in FIG. 13A.

FIG. 13C to FIG. 13E are each a plan view of the opposing portions 31a of the electrodes 31 as viewed from the upper side.

In each of the cases of FIG. 13C to FIG. 13E, the opposing portions 31a are separated in a direction perpendicular to the rotation axis R0 with the rotation axis R0 interposed therebetween. In the case where the rib 26a is formed as shown in FIG. 13A, for example, the opposing portions 31a are formed in the same shape as the shape of the rib 26a, as shown in FIG. 13C. In the case where the rib 26a is formed as shown in FIG. 13B, for example, the opposing portions 31a are formed in the same shape as the shape of the rib 26a, as shown in FIG. 13D. The opposing portions 31a do not necessarily have to have the same shape as the rib 26a, and may have, for example, a shape as shown in FIG. 13E as long as the opposing portions 31a are separated in the direction perpendicular to the rotation axis R0.

### Modification 7

In the drive element 20, it is preferable to perform surface treatment on the upper surface 20a of the drive element 20 such that light is not reflected except on the reflection surface 27.

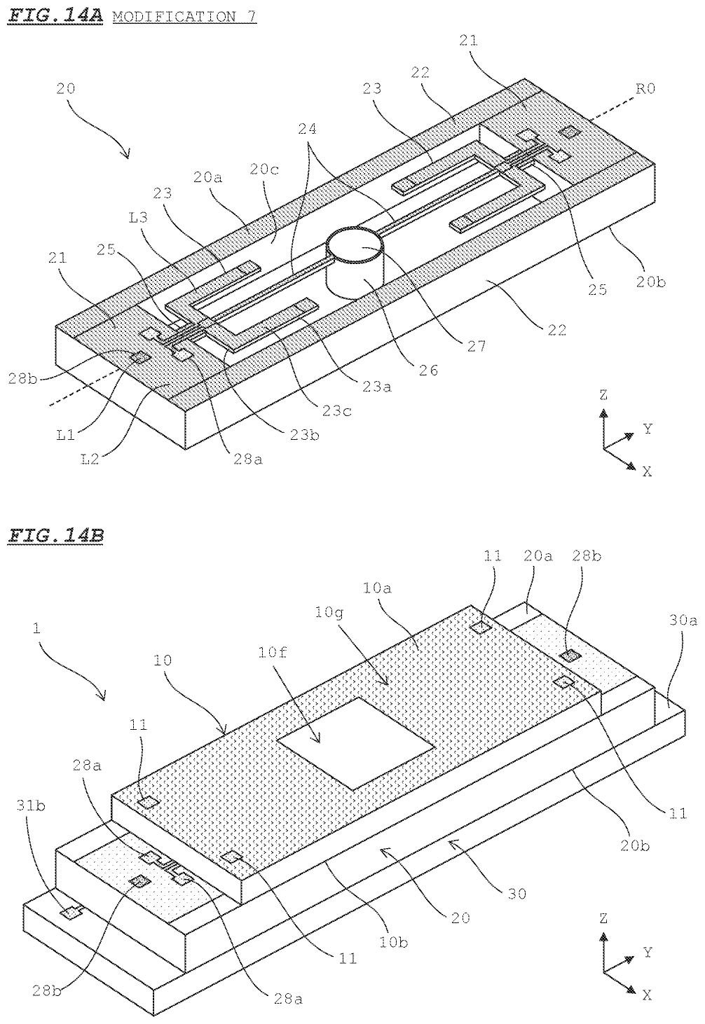

FIG. 14A is a perspective view of a drive element 20 according to Modification 7 as viewed from the upper side.

In Modification 7, compared to the above embodiment, for example, a black coating material is applied to a portion of the upper surface 20a of the drive element 20 other than the reflection surface 27 and the terminals 28a and 28b such that reflection of light is suppressed. Alternatively, by providing minute irregularities on the portion of the upper surface 20a of the drive element 20 other than the reflection surface 27 and the terminals 28a and 28b, treatment for preventing reflection of light on this portion may be performed.

With this configuration, light incident on the light deflector 1 is inhibited from being reflected by the portion other than the reflection surface 27 and the terminals 28a and 28b, so that only light reflected properly by the reflection surface 27 can be guided to the target region.

Surface treatment may be performed on the upper surface 10a such that, of light incident from the Z-axis positive side of the upper lid 10, light other than light incident on the reflection surface 27 is not reflected by the upper surface 10a of the upper lid 10.

FIG. 14B is a perspective view showing a configuration of a light deflector 1 in this case.

In this modification, compared to the above embodiment, a transmission region 10f through which light incident on the reflection surface 27 and light reflected by the reflection surface 27 pass is provided in the upper surface 10a of the upper lid 10. The transmission region 10f is at a position above the movable part 26. The upper lid 10 in the transmission region 10f is configured such that light passes therethrough as in the vicinity of the center of the upper lid 10 in the above embodiment. A light-blocking region 10g of the upper surface 10a other than the transmission region 10f is processed such that reflection of light thereon is suppressed. For example, a shape of fine irregularities is formed in the light-blocking region 10g of the upper surface 10a. Alternatively, the light-blocking region 10g may be coated so as to prevent reflection of light.

With this configuration, reflection of light is suppressed on the upper surface 10a of the upper lid 10 except at the position above the movable part 26, so that only proper light reflected by the reflection surface 27 can be guided to the target region.

### Modification 8

In the above embodiment, as shown in FIG. 2A and FIG. 2B, the wire of each electrode 12 in the upper lid 10 is electrically connected to the terminal 11 on the upper surface 10a side via a through wire such as TGV, but the configuration of drawing the wire from each electrode 12 is not limited thereto. For example, the TGV and the terminal 11 may be omitted, a wiring pattern corresponding to each electrode 12 may be provided in the drive element 20, and the electrode 12 and the wiring pattern of the drive element 20 may be electrically connected by metal bonding, solder bonding, or the like.

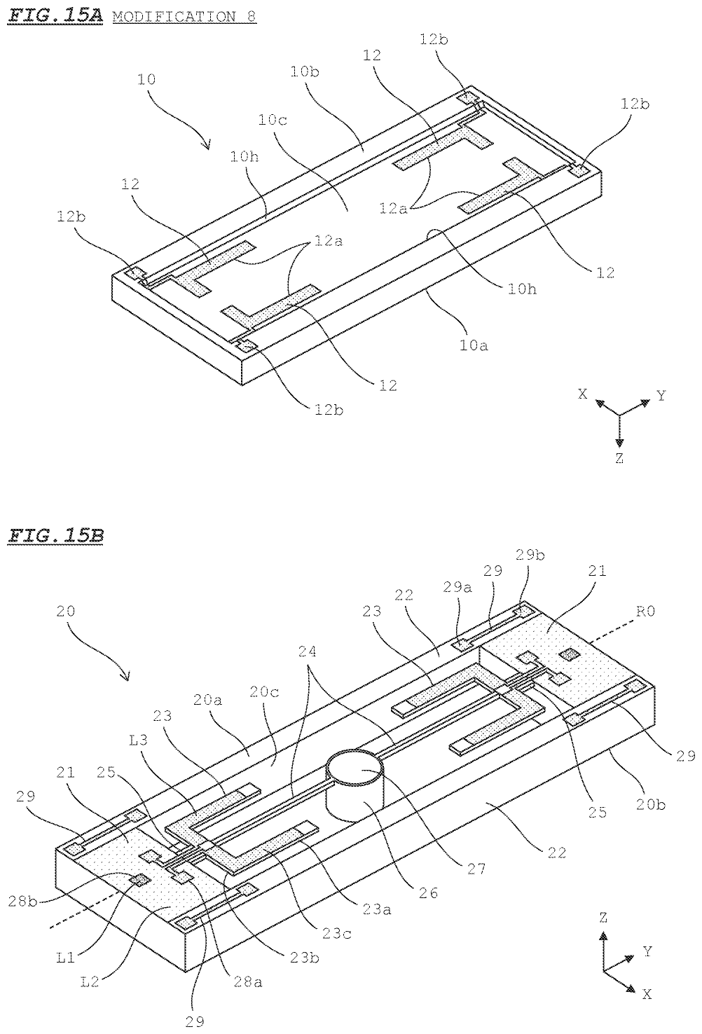

FIG. 15A and FIG. 15B are respectively a perspective view of an upper lid 10 according to Modification 8 as seen from the lower side and a perspective view of a drive element 20 according to Modification 8 as viewed from the upper side.

As shown in FIG. 15A, four slopes 10h are formed at the outer periphery of the recess 10c of the upper lid 10 so as to connect the bottom surface of the recess 10c and the lower surface 10b. Each electrode 12 extends so as to straddle the slope 10h, which extends in the Y-axis direction, in the X-axis direction. A terminal 12b is formed on the outer side in the Y-axis direction of each electrode 12.

As shown in FIG. 15B, electrodes 29 are placed around the outer sides in the Y-axis positive and Y-axis negative directions of the two frame parts 22, respectively. Terminals 29a and 29b are formed on the inner side and the outer side in the Y-axis direction of each electrode 29, respectively. The terminal 29a is placed so as to oppose the terminal 12b placed on the lower surface 10b of the upper lid 10, and the terminal 29b is placed on the outer side with respect to an end portion in the Y-axis direction of the upper lid 10. During assembly of the light deflector 1, the terminal 12b and the terminal 29a are connected by metal bonding, solder bonding, or the like. In the assembled light deflector 1, the terminal 29b is exposed upward. The terminal 29b is connected to an external circuit.

According to Modification 8, each electrode 12 on the upper lid 10 side is connected to the external circuit via the electrode 29 provided in the drive element 20. Accordingly, as in the above embodiment, the displacement state of each drive part 23 can be detected by a change in the capacitance between each electrode 12 and each drive part 23. In addition, since a TGV is not used as the configuration of drawing a wire from each electrode 12 to the outside, the cost for the configuration of drawing a wire from each electrode 12 can be reduced as compared to the above embodiment.

In Modification 4 above shown in FIG. 11A and FIG. 11B as well, a through wire such as TSV and the terminal 11 may not necessarily be used as the configuration of drawing a wire from each electrode 12. In this case as well, as in FIG. 15A and FIG. 15B, an electrode 29 corresponding to each electrode 12 is provided in the drive element 20, and the terminal 12b of the electrode 12 and the terminal 29a of the electrode 29 are connected by metal bonding, solder bonding, or the like.

### Other Modifications

In the above embodiment, each piezoelectric driver 23c is formed on the upper surfaces of the arm portion 23a and the coupling portion 23b, but may be formed on only the upper surface of the arm portion 23a.

In the above embodiment, one piezoelectric driver 23c is placed on each drive part 23, and the drive part 23 is driven by the piezoelectric driver 23c. However, a piezoelectric driver 23c for detection may be placed on each drive part 23 separately from a piezoelectric driver 23c for driving. In this case, an upper electrode L3 of the piezoelectric driver 23c for detection is connected to an external circuit without intersecting an upper electrode L3 of the piezoelectric driver 23c for driving. The drive of the drive part 23 is detected on the basis of a change in the capacitance between the upper electrode L3 for detection and the electrode 12 of the upper lid 10. With this configuration, since the resistance value of the upper electrode L3 for detection is smaller than that of the Si layer made of low-resistance silicon as in the above embodiment, the change in the capacitance between the drive part 23 and the electrode 12 can be increased, so that the drive state of the drive part 23 can be detected more accurately.

In the above embodiment, the two opposing portions 31a are placed at the center of the lower lid 30 such that the rotation axis R0 is interposed therebetween in a plan view. However, an opposing portion 31a may be placed on only one side of the rotation axis R0 in a plan view. For example, one of the two electrodes 31 may be omitted. In this case as well, the capacitance between the rib 26a and the electrode 31 placed on the one side of the rotation axis R0 changes in accordance with the displacement of the rib 26a. Therefore, the displacement state of the rib 26a can be detected by a change in the capacitance between the electrode 31 and the rib 26a.

In the above embodiment, the lower surface 10b of the upper lid 10 and the upper surface 20a of the drive element 20 are fixed by an adhesive such as frit glass or a resin, and the upper surface 30a of the lower lid 30 and the lower surface 20b of the drive element 20 are fixed by metal bonding (e.g., Au—Au or the like) or adhesive bonding (adhesion by frit glass, a resin, or the like). However, the method of fixation is not limited thereto. For example, the lower surface 10b of the upper lid 10 and the upper surface 20a of the drive element 20 may be fixed by metal bonding. In this regard, when an adhesive is used, gases generated from the adhesive may enter the closed space S. In contrast, in the case of metal bonding, since bonding is performed by metal melting caused by heat, unwanted gases are less likely to be generated, so that the closed space S can be properly brought into a state of being filled with a predetermined gas or into a vacuum state.

In the above embodiment, the lower surface 10b of the upper lid 10 and the region, surrounding the opening 20c, of the upper surface 20a of the drive element 20 are fixed by an adhesive such as frit glass. However, each lower electrode L1, each piezoelectric layer L2, and each upper electrode L3 may be stacked at the overlapping surface of the upper lid 10 and the drive element 20. In this case, by performing metal bonding (e.g., Au—Au eutectic bonding or the like) at the overlapping surface, the reliability of the bonding between the upper lid 10 and the drive element 20 can be enhanced.

In Modification 2 above, the distance between the lower surface of each drive part 23 and the upper surface 30a of the lower lid 30 may be set so as to permit the drive width in the downward direction of the drive part 23 during the specified rotational movement of the movable part 26. In this case, depending on the thickness of the lower lid 30, a protrusion or recess may be provided on the upper surface 30a of the lower lid 30 at a position opposing the lower surface of each drive part 23. Since the gap between the lower surface of each drive part 23 and the upper surface 30a of the lower lid 30 is set to a gap that permits the specified drive movement of each drive part 23, each drive part 23 can be inhibited from being excessively displaced in the downward direction.

In Modification 2 above, the upper surface 20a of the drive element 20 may be painted black as in FIG. 14A, and a light-blocking region 10g may be formed as in FIG. 14B. Accordingly, only proper light reflected by the reflection surface 27 can be further guided to the target region. It is also possible to prevent unintended reflection on the upper lid 10 by applying an AR coating (not shown) to at least a portion of the upper lid 10 that is a path for light from the outside.

In the above embodiment and Modification 5, the entire upper lid 10 is made of a light-transmitting material, but the present invention is not limited thereto, and at least a portion, above the movable part 26, of the upper lid 10 only needs to be made of a light-transmitting material. Also, in the modification shown in FIG. 12B, at least a portion, above the movable part 26, of the inclined portion 14 only needs to be made of a light-transmitting material. Since at least the portion above the movable part 26 is made of a light-transmitting material as described above, light incident from the outside through this portion can be guided to the reflection surface 27, and light reflected by the reflection surface 27 can be guided to the outside.

In the above embodiment, the structures each including a fixing part 21, two drive parts 23, a first connection part 24, and a second connection part 25 are placed on the Y-axis positive side and the Y-axis negative side of the movable part 26 so as to be symmetrical about the center of the movable part 26 in a plan view. However, such a structure may be placed on either one of the Y-axis positive side and the Y-axis negative side of the movable part 26.

In the above embodiment, the electrodes 12 and 31 for detecting the displacement of the drive element 20 are respectively placed in the upper lid 10 and the lower lid 30 for restricting excessive displacement of the drive element 20. However, only from the viewpoint of detecting the displacement of the drive element 20 using electrodes, the electrodes for detecting the displacement of the drive element 20 may not necessarily be placed in the upper lid 10 and the lower lid 30. That is, the light deflector 1 may be configured to include an opposing portion opposing a displacement portion of the drive element 20 and an electrode placed on the opposing portion. In this case, the displacement portion only needs to be a portion that is displaced when the drive element 20 is driven, and may be, for example, both or either of each drive part 23 and the movable part 26. In addition, the opposing portion only needs to be composed of a member installed in the drive element 20 so as to oppose both or either of each drive part 23 and the movable part 26, and may be a bridge-like or frame-like member installed on the upper surface or the lower surface of the drive element 20, for example, in addition to the upper lid 10 and the lower lid 30 as in the above embodiment.

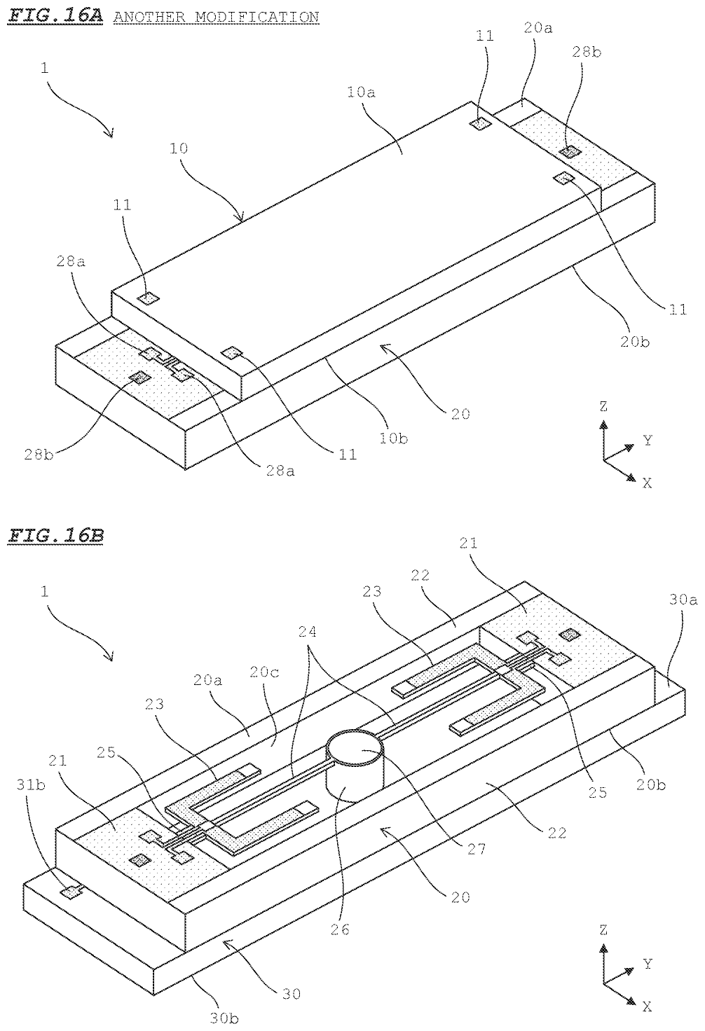

In the above embodiment, the upper lid 10 and the lower lid 30 are placed above and below the drive element 20, respectively, but only one of the upper lid 10 and the lower lid 30 may be placed. That is, the light deflector 1 may have a configuration in which the upper lid 10 is superposed on the upper surface 20a of the drive element 20 as shown in FIG. 16A, or may have a configuration in which the lower lid 30 is superposed on the lower surface 20b of the drive element 20 as shown in FIG. 16B.

In the case of FIG. 16A, the upper lid 10 opposes the upper surface 20a of the drive element 20 with a gap that permits the specified rotational movement of the movable part 26. With this configuration, the displacement of the drive element 20 when an impact is applied from the outside is restricted within the range of the gap provided between the drive element 20 and the upper lid 10. In the case of FIG. 16B, the lower lid 30 opposes the lower surface 20b of the drive element 20 with a gap that permits the specified rotational movement of the movable part 26. With this configuration, the displacement of the drive element 20 when an impact is applied from the outside is restricted within the range of the gap provided between the drive element 20 and the lower lid 30.

Therefore, in each of the cases of FIG. 16A and FIG. 16B, each drive part 23 and the movable part 26 can be inhibited from being excessively displaced, so that damage to the drive element 20, such as cutting off of the first connection part 24 and the second connection part 25 due to excessive displacement thereof, can be avoided. Since the drive element 20 is inhibited from being excessively displaced as described above, the impact resistance of the drive element 20 can be improved. However, from the viewpoint of inhibiting the drive element 20 from being excessively displaced, it is preferable to install both the upper lid 10 and the lower lid 30 on the drive element 20 as in the above embodiment.

In FIG. 16A and FIG. 16B, since only one of the upper lid 10 and the lower lid 30 is installed, the thickness of the entire light deflector 1 can be smaller than in the above embodiment. Accordingly, the light deflector 1 can be downsized, so that the cost for producing the light deflector 1 can be reduced.

In the above embodiment, the drive parts 23 form a tuning fork shape, but may form a meander structure. That is, a plurality of drive parts 23 extending in the X-axis direction may be aligned in the Y-axis direction, and two drive parts 23 adjacent to each other in the Y-axis direction may be connected at one end portion in the X-axis direction. In the case where the drive parts 23 form a meander structure as described above, a gap is provided between the upper surface of each drive part 23 and the upper lid 10 so as to permit the specified drive movement of each drive part 23. Accordingly, each drive part 23 can be inhibited from being excessively displaced.

In the case where the drive element 20 is used for other than a light deflector, the reflection surface 27 may not necessarily be placed on the movable part 26, and another member other than the reflection surface 27 may be placed on the movable part 26.

In addition to the above, various modifications can be made as appropriate to the embodiment of the present invention, without departing from the scope of the technological idea defined by the claims.

What is claimed is:

1. A light deflector comprising:
a drive element configured to rotate a movable part having a reflection surface, about a rotation axis;
an upper lid superposed on an upper surface of the drive element; and
a lower lid superposed on a lower surface of the drive element, wherein
the upper lid and the lower lid oppose the upper surface and the lower surface of the drive element, respectively, with gaps that permit specified rotational movement of the movable part.

2. The light deflector according to claim 1, wherein
a rib is formed on a lower surface of the movable part, and
the lower lid opposes a lower surface of the rib with a gap that permits the specified rotational movement of the movable part.

3. The light deflector according to claim 2, wherein the lower lid has a wall surface opposing an outer surface of the rib with a gap that permits the specified rotational movement of the movable part.

4. The light deflector according to claim 1, wherein
at least a portion, above the movable part, of the upper lid is made of a light-transmitting material, and
the upper lid covers the upper surface of the drive element without any gap.

5. The light deflector according to claim 4, wherein
the lower lid covers the lower surface of the drive element without any gap, and
a space sandwiched between the upper lid and the lower lid is a closed space.

6. The light deflector according to claim 5, wherein the closed space is filled with a gas for suppressing deterioration of the drive element.

7. The light deflector according to claim 5, wherein the closed space is in a vacuum state where air is removed therefrom.

8. The light deflector according to claim 4, wherein the upper lid includes an inclined portion inclined with respect to the rotation axis, at a position above the movable part.

9. The light deflector according to claim 1, wherein the upper lid has an opening formed at a position above the movable part.

10. The light deflector according to claim 1, wherein first electrodes are each formed on a lower surface of the upper lid so as to oppose a displacement portion of the drive element during rotational movement of the drive element.

11. The light deflector according to claim 10, wherein the first electrodes are placed such that the rotation axis is interposed therebetween.

12. The light deflector according to claim 1, wherein second electrodes are each formed on an upper surface of the lower lid so as to oppose a displacement portion of the drive element during rotational movement of the drive element.

13. The light deflector according to claim 12, wherein the second electrodes oppose a lower surface of the movable part and are separated in a direction perpendicular to the rotation axis.

14. The light deflector according to claim 1, wherein the upper surface of the drive element other than the reflection surface is subjected to surface treatment for suppressing reflection of light.

15. The light deflector according to claim 1, wherein an upper surface of the upper lid except at a position above the movable part is subjected to surface treatment for suppressing reflection of light.

16. The light deflector according to claim 1, wherein the drive element includes:
a fixing part;
the movable part;
a connection part extending along the rotation axis and connecting the fixing part and the movable part;
a pair of arm portions extending in a direction parallel to the rotation axis with the rotation axis interposed therebetween;
coupling portions coupling the pair of arm portions to the connection part; and
piezoelectric drivers placed on the pair of arm portions.

17. A light deflector comprising:
a drive element configured to rotate a movable part having a reflection surface, about a rotation axis; and
an upper lid superposed on an upper surface of the drive element, wherein
the upper lid opposes the upper surface of the drive element with a gap that permits specified rotational movement of the movable part.

18. A light deflector comprising:
a drive element configured to rotate a movable part having a reflection surface, about a rotation axis; and
a lower lid superposed on a lower surface of the drive element, wherein
the lower lid opposes the lower surface of the drive element with a gap that permits specified rotational movement of the movable part.
